(19) United States
(12) Patent Application Publication
(10) Pub. No.: US 2012/0247605 A1
(43) Pub. Date: Oct. 4, 2012

(54) Molybdenum-Free, High-Strength, Low-Alloy X80 Steel Plates Formed by Temperature-Controlled Rolling Without Accelerated Cooling

(76) Inventor: Amar K. De, Munster, IN (US)

(21) Appl. No.: 13/437,400

(22) Filed: Apr. 2, 2012

Related U.S. Application Data
(60) Provisional application No. 61/516,266, filed on Apr. 1, 2011.

(51) Int. Cl. F16L 9/00; B21C 37/06; C22C 38/04

(52) U.S. Cl. 138/177; 420/120; 72/368

(57) ABSTRACT

Steel alloy, plate, and longitudinally welded pipe formed from a molybdenum-free, high-strength, low-alloy steel, said steel alloy consisting essentially of, in wt. %: C: 0.05-0.09; Mn: 1.70-1.95; Ti: 0.01-0.02; Al: 0.02-0.055; Nb: 0.075-0.1; P: ≦0.015; S: ≦0.003; V 0.01-0.03; Mo: ≦0.003; and the remainder Fe and inevitable impurities. The plate is produced by rolling from a slab without the use of accelerated cooling.

### CROSS-REFERENCE TO RELATED APPLICATIONS

This application claims the benefit under 35 U.S.C. 119(e) of U.S. Provisional Application No. 61/516,266 filed Apr. 1, 2011.

### FIELD OF THE INVENTION

The present invention relates to plate steels, and more specifically to plate steels to be formed into longitudinally welded steel pipe. Most specifically the invention relates to plate steel that meets API-X80 specifications and is produced by temperature controlled rolling, without the use of accelerated cooling.

### BACKGROUND OF THE INVENTION

There has been increased market demand for higher strength linepipe steels for use in long distance pipelines allowing oil and gas to be transported at higher operating pressures. Many of the planned future pipeline projects such as the Alaskan Natural Gas Pipeline forecast use of large diameter high strength, high toughness pipes. Large diameter, higher strength pipelines are preferred for reduction in overall material weight, transportation and field construction costs. Though spiral welded pipes are finding increased acceptance in the construction of large diameter pipelines, longitudinally welded large diameter pipes are preferred for increased pipeline integrity and safety.

The advent of thermo-mechanical processing of high-strength-low-alloy (HSLA) steels has been a blessing to plate metallurgists in developing cost effective higher strength plates. Traditionally the focus of development has been the linepipe sector due to the ever increasing demand for higher strength/higher toughness plates for manufacturing of large diameter pipes for oil and gas transmission, but when the advantages of non-heat-treated (as-rolled) high strength plates for various structural type applications were realized, new areas of development could be explored. Substitution of as-rolled plates for heat treated ones presents numerous advantages to fabricators, such as better surface finish, improved flatness, more formability, and welding without pre-heating, to name a few. Additional significant benefits are lower material and fabrication costs and an improved final product.

From the perspective of metallurgy, the most effective processing method for producing 500 MPa and greater yield strength discreet rolled plates with lean chemical composition is controlled rolling paired with accelerated cooling. Controlled rolling of austenite is aimed at conditioning the austenite by working in the unrecrystallized region to the maximum extent for making the greatest surface area available for later transformation. For almost all Thermo-Mechanical Controlled Processing (TMCP) grades, there is universal unanimity in the primary processing approach for austenite conditioning. Usually, thermo-mechanical controlled processing (TMCP) consists of “temperature-controlled rolling” followed by accelerated cooling with application of water as quickly as possible after completion of rolling. It is the later controlled cooling part that often makes it difficult for plate mills to produce thinner plates (<=16 mm) with acceptable flatness and shape. Thinner plates after accelerated cooling and hot leveling may buckle during cooling on the plate cooling bed. Re-leveling in the cold condition is not desirable as it not only takes a toll on the productivity of the mill but it induces residual stresses which will result in increased potential springback and other distortions when the plate is sectioned.

The ArcelorMittal USA Burns Harbor 160″ Plate Mill (BH Plate) finds itself in an advantageous position of being able to roll plates up to 150″ (3810 mm) wide so that pipes of up to 48″ (1220 mm) diameter can be produced from these plates. However, on the finishing end of BH Plate, the finish rolled plate has to traverse about 60 m before it enters the accelerated cooling unit and this causes a significant temperature difference between the front and tail ends of the plate as it enters the accelerated cooling unit. The temperature drop and difference are problematic when rolling thinner and wider plates as temperature dissipation is faster. As a result, shape distortions occur due to differential thermal stresses resulting from non-uniform cooling. This causes a significant production related issue for the mill.

Thus, to keep pace with market indications for substantial future requirements of API 5L L555(X80) grade linepipe plates there is a need in the art for an alloy design together with a disciplined TMCP practice to produce high strength linepipe plates without the use of accelerated cooling. To fill this need, a product development program was undertaken by the present inventor for the production of X80 grade plates at without accelerated cooling.

### SUMMARY OF THE INVENTION

The present invention relates to a steel alloy, steel plate formed from the alloy, and a longitudinally welded pipe formed from the steel plate. The steel alloy is a molybdenum-free, high-strength, low-alloy steel, said steel alloy consisting essentially of, in wt. %: C: 0.05-0.09; Mn: 1.70-1.95; Ti: 0.01-0.02; Al: 0.02-0.055; Nb: 0.075-0.1; P: ≦0.015; S: ≦0.003; V 0.01-0.03; Mo: ≦0.003; and the remainder Fe and inevitable impurities. The plate is produced by rolling from a slab without the use of accelerated cooling.

The steel plate has an API-X80 rating and is between 6 and 16 mm thick. The plate is produced by heating and soaking a slab of the steel composition up to 1230° C.; starting finishing rolling of said slab at a temperature of between 970-1020° C.; ending finishing rolling of said steel plate at a temperature of between 675-715° C.; applying a total finishing deformation of 60-80% to form said steel plate; and cooling said steel plate without the use of accelerated cooling. The step of cooling said steel plate without the use of accelerated cooling may be ambient air cooling of said steel plate, which may provide a cooling rate of about 1-2° C./s.

The steel pipe may be formed by rolling said plate into a tube and longitudinally welding the seam. The pipe may be 36″ or even 48″ OD. The pipe meets API-X80 specifications.

### BRIEF DESCRIPTION OF THE FIGURES

FIG. 1 is a plot of strength in Mpa versus plate thickness in mm indicating that the Mo-free alloy plates of the present invention meet API-X80 specifications;

FIG. 2 is a plot of CVN impact energy values in Joules at −23° C. versus plate thicknesses in mm for both Mo-alloyed and Mo-free plate compositions;

FIG. 3 is a plot of CVN impact energies in Joules versus temperature in ° C. for various temperatures for both Mo-alloyed and Mo-free plate compositions;

FIG. 4a is a plot of yield strength in Mpa versus pipe number, also plotted is the yield strength of the corresponding plate from which the pipe was formed;

FIG. 4b plots the drop in yield strength between the pipe and the plate from which the pipe was formed versus pipe number;

FIG. 5a plots the CVN impact energies in Joules versus temperature for 10.3 mm thick Mo-alloyed and Mo-free alloy plates and their respective pipes; and

FIG. 5b plots the CVN impact energies in Joules versus temperature for 16 mm thick Mo-alloyed and Mo-free alloy plates and their respective pipes.

### DETAILED DESCRIPTION OF THE INVENTION

The present inventor proposed an alloy design together with a disciplined TMCP practice to produce high strength linepipe plates. The proposed chemistry and processing design allows for the production of thinner gauge API X80 linepipe plates without the use of accelerated cooling employing only controlled processing conditions.

Accelerated cooling lowers the Ar₃ temperature and greatly increases the number of ferrite nuclei. Additionally, intragranular nuclei for ferrite are also induced at deformation bands within deformed and unrecrystallized austenite. In the absence of accelerated cooling, therefore, one might expect much of the ferrite grain refinement to be lost. The present inventor has explored alternate processing methods such as low temperature controlled processing below Ar₃ temperature. Low temperature processing significantly increases ferrite yield strength through the introduction of dislocation substructures. The lower the temperature of finishing deformation the higher the yield strength.

Additionally, molybdenum has been used for high strength plate development using only controlled rolling for many of its processing and metallurgical advantages, namely Mo:

(i) lowers the transformation temperature thereby widening the single phase γ-region for austenite conditioning and restricting ferrite growth after transformation, leading to finer precipitates,
(ii) inhibits pearlite transformation and gives rise to bainite or acicular ferrite formation, and
(iii) increases substructure strengthening of ferrite.

The loss of reduction of the Ar3 temperature provided by accelerated cooling can be compensated for by the following two design criterion:

### (1) An Alloy Design that Significantly Lowers the Ar₃ Using the Formula

Ar₃(° C.)=910−310C−80Mn−20Cu−15Cr−55Ni−80Mo−0.35(t−8)

where, the elemental composition of the alloying elements (C, Mn, Cu, Cr, Ni, and Mo) are in wt. % and t is plate thickness in mm. Low Ar₃ suppresses grain growth of already transformed ferrite.

Both Mn and Mo act favorably in the reduction of Ar₃. Mo inhibits pearlite formation during air cooling and aids in the formation of bainite or acicular ferrite. Mo—Nb alloying also helps to retain austenite or martensite-austenite constituent within the fine elongated ferrite grains which can minimize yield strength drop during pipemaking due to the Bauschinger effect.

### (2) Extending Controlled Processing of the Deformed and Unrecrystallized Austenite Down to Intercritical Region (γ+α)

This results in significant strengthening of already transformed ferrite through the introduction of sub grains and dislocation substructures. Further, due to a widened working range, more unrecrystallized austenite is formed which increases number of ferrite nuclei and refines the grain size.

The response of Mo to controlled low temperature processing was studied with regard to microstructure and mechanical property development. An attempt has been made to explore alloy design that would facilitate microstructure and property development suitable for structural applications requiring high strength, high toughness plates, i.e. API-X80 plates. The API-X80 specification requirements are given in Table 1.

TABLE 1
API-X80 mechanical specifications

| Yield strength MPa (kpsi) | | Tensile strength MPa (kpsi) | | Ratio YS/TS |
|---|---|---|---|---|
| Min | Max | Min | Max | Max |
| 555 (80.5) | 705 (102.3) | 625 (90.6) | 825 (119.7) | 0.93 |

The present inventor chose both Mo-alloyed and Mo-free compositions to test production using controlled temperature rolling without accelerated cooling. C—Mn—Nb and C—Mn—Nb—Mo compositions were selected. The general compositions are given in Table 2 (note that the remainder of the alloy is Fe and inevitable impurities).

TABLE 2
General Steel Compositions

| Steels | C | Mn | P | S | Si | Mo | V | Ti | Al | Nb |
|---|---|---|---|---|---|---|---|---|---|---|
| Mo | 0.05-0.09 | 1.70-1.95 | <0.015 | <0.003 | 0.25-0.4 | >=0.30 | 0.01-0.03 | 0.01-0.02 | 0.02-0.055 | 0.075-0.1 |
| Mo-Free | | | | | | <0.003 | | | | |

Table 3 lists the composition of 7 samples of the Mo-free steel composition of the present invention. While the Mo concentration is not absolutely 0%, there is no intentional addition of Mo and only very small trace amounts exist in the actual samples.

TABLE 3
Mo-Free Compositions

| Sample # | C | Mn | P | S | Si | Cu | Ni | Cr | Mo | V | Ti | Al | Nb | N | B |
|---|---|---|---|---|---|---|---|---|---|---|---|---|---|---|---|
| Mo-Free 1 | 0.08 | 1.85 | 0.007 | 0.001 | 0.348 | 0.022 | 0.02 | 0.02 | 0.003 | 0.017 | 0.014 | 0.041 | 0.083 | 0.008 | 0.0001 |
| Mo-Free 2 | 0.06 | 1.87 | 0.007 | 0.001 | 0.358 | 0.021 | 0.01 | 0.02 | 0.002 | 0.18 | 0.015 | 0.037 | 0.087 | 0.006 | 0.0001 |
| Mo-Free 3 | 0.06 | 1.88 | 0.007 | 0.001 | 0.373 | 0.018 | 0.01 | 0.02 | 0.003 | 0.017 | 0.015 | 0.038 | 0.087 | 0.006 | 0.0001 |
| Mo-Free 4 | 0.06 | 1.9 | 0.008 | 0.001 | 0.364 | 0.017 | 0.01 | 0.02 | 0.003 | 0.017 | 0.012 | 0.034 | 0.086 | 0.009 | 0.0002 |
| Mo-Free 5 | 0.07 | 1.87 | 0.008 | 0.001 | 0.367 | 0.019 | 0.01 | 0.02 | 0.003 | 0.017 | 0.015 | 0.039 | 0.087 | 0.007 | 0.0001 |
| Mo-Free 6 | 0.07 | 1.87 | 0.006 | 0.001 | 0.375 | 0.018 | 0.01 | 0.02 | 0.003 | 0.018 | 0.015 | 0.038 | 0.087 | 0.008 | 0.0001 |
| Mo-Free 7 | 0.07 | 1.85 | 0.007 | 0.001 | 0.353 | 0.018 | 0.01 | 0.02 | 0.002 | 0.019 | 0.018 | 0.04 | 0.092 | 0.007 | 0.0001 |

The heats were made at ArcelorMittal Indiana Harbor Plant and Ca-treated for sulfide shape control and continuously cast to slabs of 233 mm thickness. The slabs were hot rolled using controlled processing conditions given in Table 4. The plates were rolled to thicknesses of 9.5, 10.3, 12.7 and 16 mm and formed without accelerated cooling.

TABLE 4
Plate Rolling Conditions

| Slab Reheat | Start Finish | End Finish | Total Finish |
|---|---|---|---|
| Temp. ° C. | Rolling Temp. ° C. | Rolling Temp. ° C. | Deformation % |
| 1230 | 970-1020 | 675-715 | 60-80 |

### Mechanical Properties

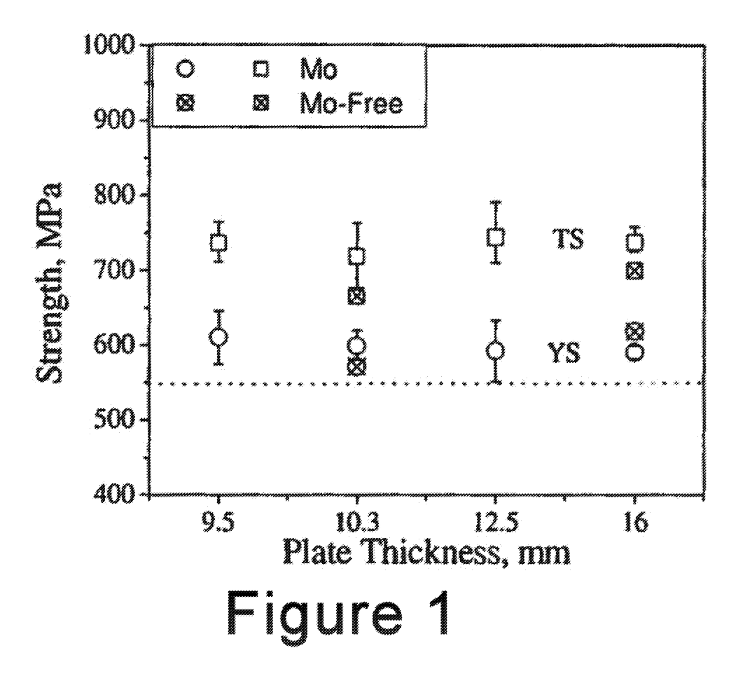

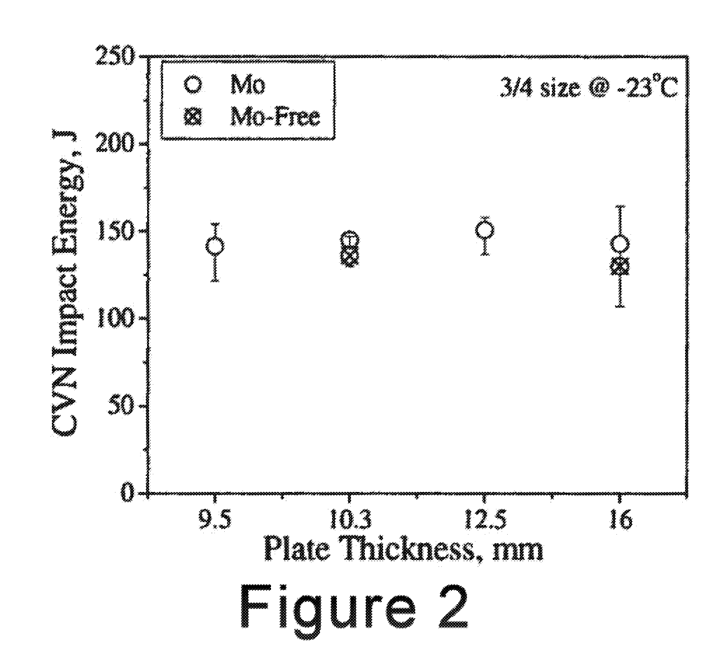

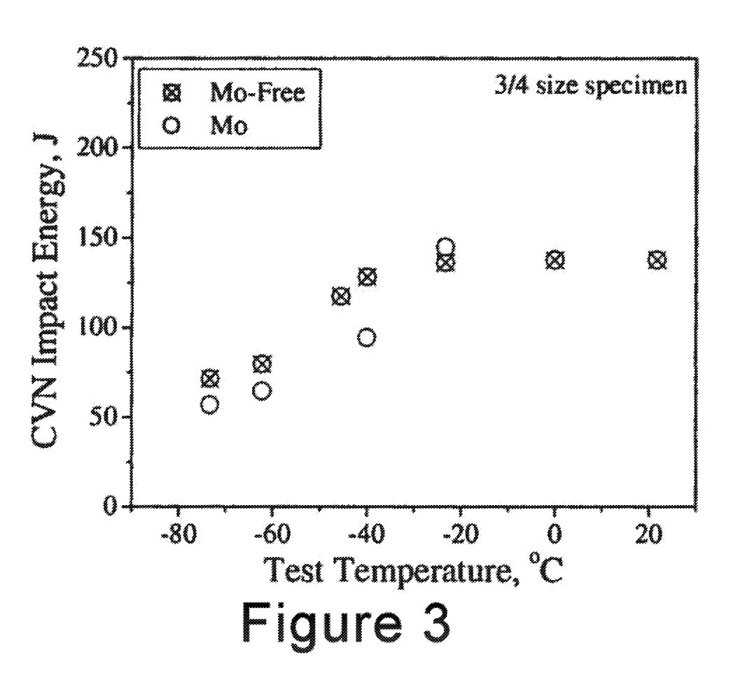

As anticipated, the mechanical properties of Mo-alloyed steel plates met the API-X80 specification requirements, but completely unexpectedly, the Mo-free steel plates also met the API-X80 specifications. The mechanical properties of Mo-alloyed and Mo-free plate samples are summarized in FIGS. 1-3. It can be seen From FIG. 1 that API-X80 specified strength properties were obtained in both Mo-alloyed and Mo-free plates in all thicknesses processed. FIG. 1 is a plot of strength in Mpa versus plate thickness in mm. Both the yield strength (YS) and tensile strength TS are plotted for both Mo-alloyed and Mo-free plate compositions. Higher tensile strengths were recorded for Mo-alloyed plates. Mo-free plates have 1-1.5% yield point elongation (YPE) whereas Mo-alloyed plates have a continuous flow behavior with significant strain-hardening. Both alloy plates manifested 11-12% uniform elongation. FIG. 2 is a plot of CVN impact energy values in Joules at −23° C. versus plate thicknesses in mm for both Mo-alloyed and Mo-free plate compositions. It should be noted that the bars on the data points of FIGS. 1 and 2 are estimated error range bars. A comparison of CVN impact energies in Joules versus temperature in ° C. for various temperatures for both Mo-alloyed and Mo-free samples is presented in FIG. 3. Both plate samples showed similar impact toughness behavior however, Mo-free samples indicated a slightly higher low temperature toughness than the Mo-alloyed plate samples.

### Pipemaking

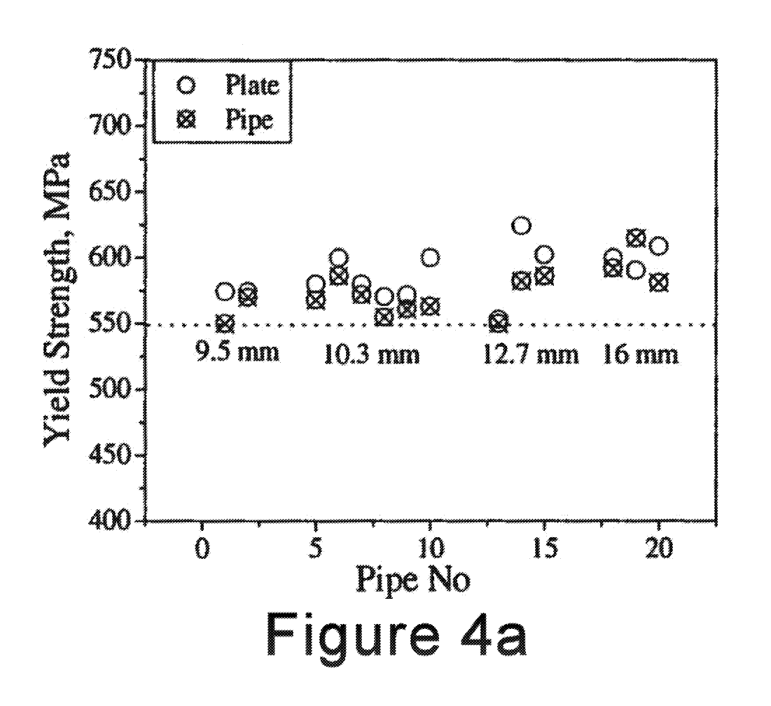

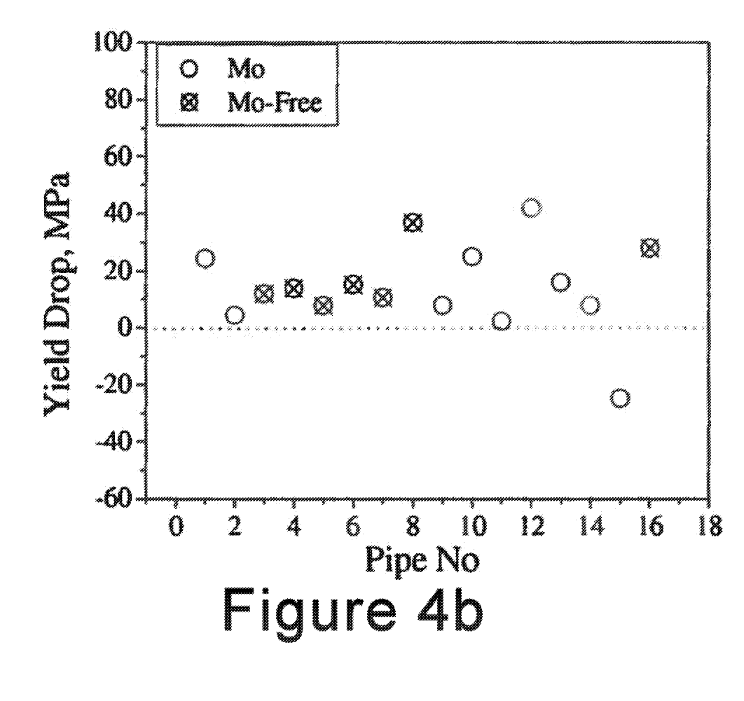

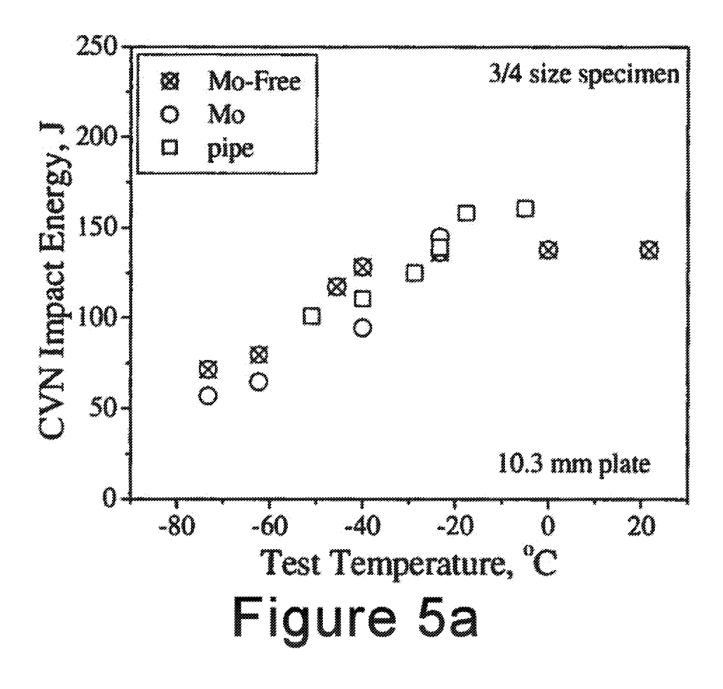

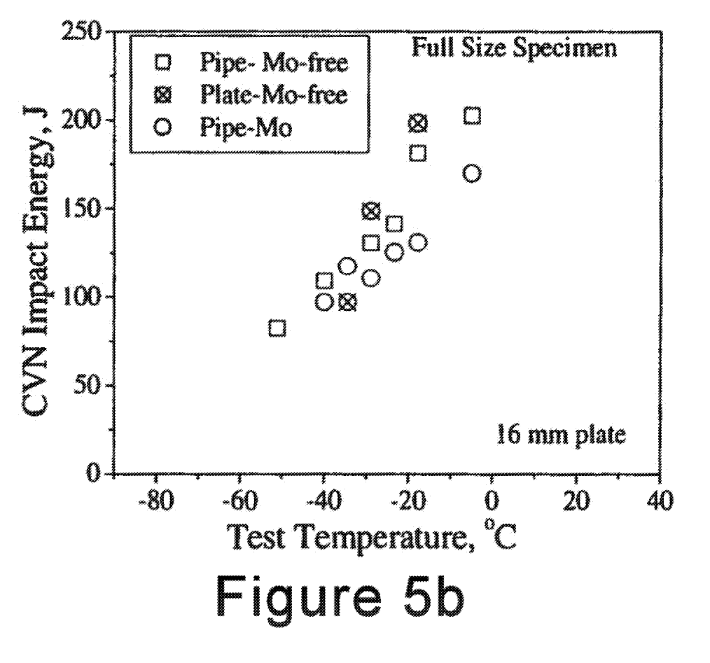

The plates were formed into 36″ OD (2871 mm) longitudinally welded non-expanded pipes and samples cut from formed pipes were evaluated as required by API specification. All the 9.5 mm, 10.3 mm, 12.7 mm and 16 mm plates were successfully formed into pipes and the mechanical properties of samples collected from pipe are given in FIGS. 4a and 4b. FIG. 4a is a plot of yield strength in Mpa versus pipe number, also plotted is the yield strength of the corresponding plate from which the pipe was formed. All the pipes met the specified X80 properties. FIG. 4b plots the drop in yield strength between the pipe and the plate from which the pipe was formed versus pipe number. The drop in yield strength after pipe forming was found to be 2-40 MPa in most cases and no distinctive difference between to Mo-alloyed and Mo-free alloys could be ascertained from the obtained data. Charpy impact toughness values of pipe body samples are shown in FIGS. 5a (10.3 mm plates) and 5b (16 mm plates). FIG. 5a plots the CVN impact energies in Joules versus temperature for 10.3 mm thick Mo-alloyed and Mo-free alloy plates and their respective pipes. FIG. 5b plots the CVN impact energies in Joules versus temperature for 16 mm thick Mo-alloyed and Mo-free alloy plates and their respective pipes. The pipe Charpy impact toughness values are very similar to those obtained in plates. While plates of 36″ OD were produced, pipes of up to 48″ OD are envisioned by the present inventor, given the plate width capabilities of the Burns Harbor plate mill.

API X80 grade linepipe plates were produced using Mo-free and Mo-alloyed alloy compositions in plate thicknesses up to 16 mm using a controlled processing approach without use of accelerated cooling. As used herein, accelerated cooling will mean cooling at a rate of about 18° F./s to 24° F./s, which is generally accomplished by water cooling. Also as used herein, without accelerated cooling will mean natural cooling in ambient air at a cooling rate of about 1-2° C./s.

The plates were processed just below Ar3 temperature in the two phase (γ+α) region and the microstructures, mechanical properties, crystallographic orientations were analyzed. The plates were further formed into 36″ OD longitudinally welded non-expanded pipes and the material properties after pipe forming were evaluated. The results revealed that API X80 properties can be successfully obtained in plates up to 16 mm using a controlled processing approach with a Mo-alloyed or Mo-free C—Mn—Nb type composition. As used herein, the minimum thickness that is considered a plate is about 6 mm.

It is to be understood that the disclosure set forth herein is presented in the form of detailed embodiments described for the purpose of making a full and complete disclosure of the present invention, and that such details are not to be interpreted as limiting the true scope of this invention as set forth and defined in the appended claims.

We claim:

1. A molybdenum-free, high-strength, low-alloy steel for the production of steel plates, said steel alloy consisting essentially of, in wt. %:
C: 0.05-0.09; Mn: 1.70-1.95; Ti: 0.01-0.02; Al: 0.02-0.055; Nb: 0.075-0.1; P: ≦0.015; S: ≦0.003; V 0.01-0.03; Mo: ≦0.003; and the remainder Fe and inevitable impurities.

2. A steel plate formed from a molybdenum-free, high-strength, low-alloy steel, said steel alloy consisting essentially of, in wt. %:
C: 0.05-0.09; Mn: 1.70-1.95; Ti: 0.01-0.02; Al: 0.02-0.055; Nb: 0.075-0.1; P: ≦0.015; S: ≦0.003; V 0.01-0.03; Mo: ≦0.003; and the remainder Fe and inevitable impurities.

3. The steel plate of claim 2, wherein said steel plate has an API-X80 rating.

4. The steel plate of claim 3, wherein said steel plate is between 6 and 16 mm thick.

5. The steel plate of claim 2, wherein said steel plate is formed by the steps of:
heating and soaking a slab of the steel composition up to 1230° C.;
starting finishing rolling of said slab at a temperature of between 970-1020° C.;
ending finishing rolling of said steel plate at a temperature of between 675-715° C.;
applying a total finishing deformation of 60-80% to form said steel plate;
cooling said steel plate without the use of accelerated cooling.

6. The steel plate of claim 5, wherein said step of cooling said steel plate without the use of accelerated cooling comprises ambient air cooling of said steel plate.

7. The steel plate of claim 6, wherein said step of ambient air cooling of said steel plate provides a cooling rate of about 1-2° C./s.

8. A steel pipe, said steel pipe being formed from a steel plate, said steel plate formed of a molybdenum-free, high-strength, low-alloy steel, said steel alloy consisting essentially of, in wt. %:
C: 0.05-0.09; Mn: 1.70-1.95; Ti: 0.01-0.02; Al: 0.02-0.055; Nb: 0.075-0.1; P: ≦0.015; S: ≦0.003; V 0.01-0.03; Mo: ≦0.003; and the remainder Fe and inevitable impurities.

9. The steel pipe of claim 8, wherein said steel plate has an API-X80 rating.

10. The steel pipe of claim 9, wherein said steel plate is between 6 and 16 mm thick.

11. The steel pipe of claim 8, wherein said steel plate is formed by the steps of:
heating and soaking a slab of the steel composition up to 1230° C.;
starting finishing rolling of said slab at a temperature of between 970-1020° C.;
ending finishing rolling of said steel plate at a temperature of between 675-715° C.;
applying a total finishing deformation of 60-80% to form said steel plate;
cooling said steel plate without the use of accelerated cooling.

12. The steel pipe of claim 11, wherein said step of cooling said steel plate without the use of accelerated cooling comprises ambient air cooling of said steel plate.

13. The steel plate of claim 12, wherein said step of ambient air cooling of said steel plate provides a cooling rate of about 1-2° C./s.

14. The steel pipe of claim 8, wherein said steel pipe is formed by rolling said plate into a tube and longitudinally welding the seam.

15. The steel pipe of claim 14, wherein said steel pipe is 36″ OD.

16. The steel pipe of claim 14, wherein said steel pipe is 48″ OD.
